(19) United States
(12) Patent Application Publication
(10) Pub. No.: US 2024/0075600 A1
(43) Pub. Date: Mar. 7, 2024

(54) ELECTRIC TOOL, METHOD FOR CONTROLLING ELECTRIC TOOL, AND PROGRAM

(71) Applicant: Panasonic Intellectual Property Management Co., Ltd., Osaka (JP)

(72) Inventors: Yusuke TANJI, Osaka (JP); Hideki TAMURA, Osaka (JP)

(73) Assignee: Panasonic Intellectual Property Management Co., Ltd., Osaka (JP)

(21) Appl. No.: 18/272,578

(22) PCT Filed: Jan. 26, 2021
(86) PCT No.: PCT/JP2021/002671

§ 371 Date: Jul. 16, 2023

(51) Int. Cl. B25B 23/147; B25B 21/02

(52) U.S. Cl. CPC B25B 23/1475; B25B 21/02

(57) ABSTRACT

An electric tool includes a motor, an impact mechanism, an output shaft, a torque measuring unit, a fastening torque calculating unit, and a control unit. The output shaft receives, from the impact mechanism, rotational impact around an axis. The torque measuring unit measures, as measured torque, torque applied to the output shaft. The fastening torque calculating unit calculates, based on the measured torque measured by the torque measuring unit, fastening torque to be applied to a fastening member. The control unit performs a speed reducing function by changing, according to the fastening torque calculated by the fastening torque calculating unit, the number of revolutions of the motor from a first number of revolutions into a second number of revolutions. The second number of revolutions is smaller than the first number of revolutions.

### TECHNICAL FIELD

The present disclosure generally relates to an electric tool, a method for controlling the electric tool, and a program. More particularly, the present disclosure relates to an electric tool including an impact mechanism, a method for controlling such an electric tool, and a program.

### BACKGROUND ART

Patent Literature 1 discloses an impact rotary tool (electric tool) including an impact mechanism, an impact detection unit, a control unit, and a voltage detection unit. The impact mechanism includes a hammer and applies impact/shock to an output shaft with the output of a motor. In this manner, impact rotary tool fastens a screw (fastening member). The impact detection unit detects the impact applied by the impact mechanism. The control unit stops the rotation of the motor based on a result of detection by the impact detection unit.

In the impact rotary tool of Patent Literature 1, if the number of revolutions of the motor is too large, for example, while the impact mechanism is applying impact/shock to the output shaft, then the fastening torque applied to the fastening member may vary so significantly with time that the accuracy of control of the fastening torque may be short of a required level.

### CITATION LIST

### Patent Literature

Patent Literature 1: JP 2017-132021 A

### SUMMARY OF INVENTION

It is therefore an object of the present disclosure to provide an electric tool, a method for controlling the electric tool, and a program, all of which are configured or designed to improve the accuracy of control of the fastening torque.

An electric tool according to an aspect of the present disclosure includes a motor, an impact mechanism, an output shaft, a torque measuring unit, a fastening torque calculating unit, and a control unit. The impact mechanism receives motive power from the motor to generate impacting force. The output shaft holds a tip tool thereon. The tip tool is used to apply either tightening force or loosening force to a fastening member. The output shaft receives, from the impact mechanism, rotational impact around an axis. The torque measuring unit measures, as measured torque, torque applied to the output shaft. The fastening torque calculating unit calculates, based on the measured torque measured by the torque measuring unit, fastening torque to be applied to the fastening member. The control unit controls operation of the motor. The control unit has a speed reducing function. The control unit performs the speed reducing function by changing, according to the fastening torque calculated by the fastening torque calculating unit, a number of revolutions of the motor from a first number of revolutions into a second number of revolutions. The second number of revolutions is smaller than the first number of revolutions.

A method for controlling an electric tool according to another aspect of the present disclosure is designed to control an electric tool including a motor, an impact mechanism, an output shaft, and a torque measuring unit. The impact mechanism receives motive power from the motor to generate impacting force. The output shaft holds a tip tool thereon. The tip tool is used to apply either tightening force or loosening force to a fastening member. The output shaft receives, from the impact mechanism, rotational impact around an axis. The torque measuring unit measures, as measured torque, torque applied to the output shaft. The method for controlling the electric tool includes a calculating step and a speed reducing step. The calculating step includes calculating, based on the measured torque measured by the torque measuring unit, fastening torque to be applied to the fastening member. The speed reducing step includes changing, according to the fastening torque calculated in the calculating step, a number of revolutions of the motor from a first number of revolutions into a second number of revolutions. The second number of revolutions is smaller than the first number of revolutions.

A program according to still another aspect of the present disclosure is designed to cause one or more processors to perform the method for controlling the electric tool described above.

### BRIEF DESCRIPTION OF DRAWINGS

FIG. 1 is a schematic representation of an electric tool according to an exemplary embodiment;

FIG. 2 is a flowchart showing an exemplary procedure of operation of the electric tool; and

FIG. 3 is a graph showing an exemplary operation of the electric tool.

### DESCRIPTION OF EMBODIMENTS

An electric tool 1, a method for controlling the electric tool 1, and a program according to an exemplary embodiment will now be described with reference to the accompanying drawings. Note that the embodiment to be described below is only an exemplary one of various embodiments of the present disclosure and should not be construed as limiting. Rather, the exemplary embodiment may be readily modified in various manners depending on a design choice or any other factor without departing from the scope of the present disclosure. Also, the drawings to be referred to in the following description of embodiments are all schematic representations. Thus, the ratio of the dimensions (including thicknesses) of respective constituent elements illustrated on the drawings does not always reflect their actual dimensional ratio.

(1) Overview

An electric tool 1 according to an exemplary embodiment is an impact tool. The electric tool 1 may be used as, for example, an impact screwdriver or an impact wrench. In the following description of embodiments, a situation where the electric tool 1 is used as an impact screwdriver for tightening or loosening a fastening member 30 (such as a screw) will be described as a typical example.

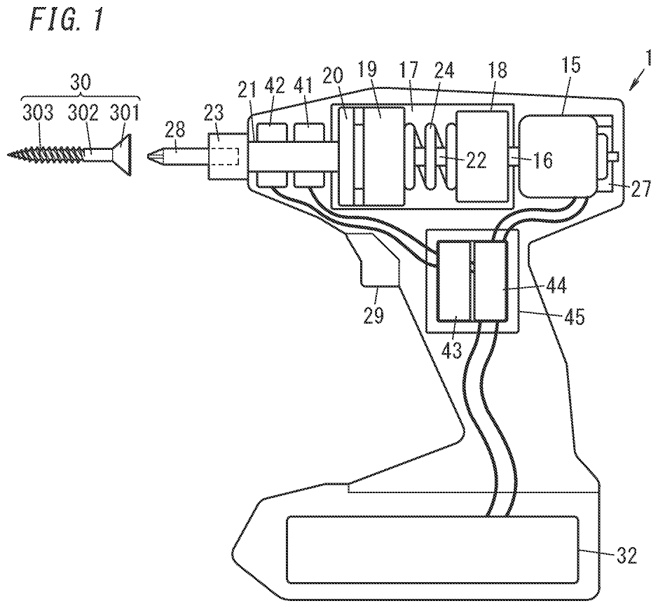

As shown in FIG. 1, the electric tool 1 includes a motor 15, an impact mechanism 17, an output shaft 21, a torque measuring unit 41, a fastening torque calculating unit 43, and a control unit 44. The impact mechanism 17 receives motive power from the motor 15 to generate impacting force. The output shaft 21 holds a tip tool 28 thereon. The tip tool 28 applies either tightening force or loosening force to a fastening member 30. The output shaft 21 receives, from the impact mechanism 17, rotational impact around an axis. The torque measuring unit 41 measures, as measured torque, torque applied to the output shaft 21. The fastening torque calculating unit 43 calculates, based on the measured torque measured by the torque measuring unit 41, fastening torque to be applied to the fastening member 30. The control unit 44 controls operation of the motor 15. The control unit 44 has a speed reducing function (i.e., performs speed reduction control). The control unit 44 performs the speed reducing function by changing, according to the fastening torque calculated by the fastening torque calculating unit 43, the number of revolutions of the motor 15 from a first number of revolutions into a second number of revolutions. The second number of revolutions is smaller than the first number of revolutions.

In the electric tool 1 according to this embodiment, the control unit 44 performs the speed reducing function to reduce the speed of the motor 15 such that the number of revolutions of the motor 15 changes from the first number of revolutions into the second number of revolutions, thus reducing a variation in fastening torque with time. This improves, when the fastening torque needs to be controlled highly accurately, the accuracy of control of the fastening torque by making the control unit 44 perform the speed reducing function to reduce the speed of the motor 15. In addition, this also reduces the chances of excessive fastening torque being applied to the fastening member 30.

(2) Details

As shown in FIG. 1, the electric tool 1 includes a power supply 32, the motor 15, a motor rotation measuring unit 27, a driving force transmission mechanism 18, the impact mechanism 17, the output shaft 21, a socket 23 (chuck), and the tip tool 28. In addition, the electric tool 1 further includes a trigger volume 29, the torque measuring unit 41, an acceleration sensor 42, the fastening torque calculating unit 43, the control unit 44, and a case 45.

The impact mechanism 17 performs an impact operation of receiving motive power from the motor 15 to generate impacting force. The impact mechanism 17 is coupled to the output shaft 21. The output shaft 21 is a part that rotates upon receiving the driving force transmitted from the motor 15. The socket 23 is fixed to the output shaft 21. The tip tool 28 is attached removably to the socket 23. The tip tool 28 rotates along with the output shaft 21. The electric tool 1 is designed to rotate the tip tool 28 by turning the output shaft 21 with the driving force applied by the motor 15. That is to say, the electric tool 1 is a tool for driving the tip tool 28 with the driving force applied by the motor 15. The tip tool 28 (also called a “bit”) may be a screwdriver bit or a drill bit, for example. One of various types of tip tools 28 is selected depending on the intended use and attached to the socket 23 for the intended use. Alternatively, the tip tool 28 may be directly attached to the output shaft 21.

The electric tool 1 according to this embodiment includes the socket 23, thus making the tip tool 28 replaceable depending on the intended use. However, the tip tool 28 does not have to be replaceable. Alternatively, the electric tool 1 may also be designed to allow the use of only a particular type of tip tool 28, for example.

The tip tool 28 according to this embodiment is a screwdriver bit for tightening or loosening the fastening member 30 (such as a screw). That is to say, the output shaft 21 holds the screwdriver bit for tightening or loosening the fastening member and rotates upon receiving motive power from the motor 15. In the following description, a situation where the fastening member is tightened by the electric tool 1 will be described as an example. Note that any type of fastening member may be used without limitation. The fastening member may be a bolt, a screw, or a nut, for example. As shown in FIG. 1, the fastening member 30 according to this embodiment is a wood screw. The fastening member 30 includes a head portion 301, a cylindrical portion 302, and a thread portion 303. The head portion 301 and the thread portion 303 are respectively connected to both ends of the cylindrical portion 302. The head portion 301 has a screw hole (such as a plus (+) hole) that fits the tip tool 28. The thread portion 303 has a thread thereon.

The tip tool 28 fits the fastening member 30. That is to say, the tip tool 28 is inserted into the screw hole on the head portion 301 of the fastening member 30. In this state, the tip tool 28 is caused to rotate by being driven by the motor 15, thereby turning the fastening member 30. As a result, the fastening member 30 is fastened (i.e., embedded) into the target member (such as wood) to be screwed. That is to say, the tip tool 28 applies tightening (or loosening) force to the fastening member 30.

The power supply 32 supplies a current for driving the motor 15. The power supply 32 may be a battery pack, for example. The power supply 32 may include, for example, either a single secondary battery or a plurality of secondary batteries.

The motor 15 may be, for example, a brushless motor. The motor 15 may be, for example, an AC motor. The motor rotation measuring unit 27 measures the rotational angle of the motor 15. As the motor rotation measuring unit 27, a photoelectric encoder or a magnetic encoder may be adopted, for example. The control unit 44 performs time differentiation on the rotational angle, measured by the motor rotation measuring unit 27, of the motor 15 to determine the number of revolutions of the motor 15. The control unit 44 controls the operation of the motor 15 based on the number of revolutions thus determined. The control unit 44 may perform, for example, feedback control on the number of revolutions of the motor 15.

The motor 15 is a drive source for driving the tip tool 28. The motor 15 includes a rotary shaft 16 for outputting rotational power. The rotary shaft 16 is connected to the driving force transmission mechanism 18. The driving force transmission mechanism 18 regulates the rotational power of the motor 15 to output desired torque. The driving force transmission mechanism 18 includes a drive shaft 22 as its output member. The drive shaft 22 is connected to the impact mechanism 17.

The impact mechanism 17 transmits the rotational power of the motor 15, which the impact mechanism 17 has received via the driving force transmission mechanism 18, to the output shaft 21. The impact mechanism 17 includes a hammer 19, an anvil 20, and a spring 24. The hammer 19 is attached to the drive shaft 22 of the driving force transmission mechanism 18 via a cam mechanism. The anvil 20 is coupled to, and rotates integrally with, the hammer 19. The spring 24 biases the hammer 19 toward the anvil 20. The anvil 20 is formed integrally with the output shaft 21. Alternatively, the anvil 20 may also be formed separately from, and be fixed to, the output shaft 21.

Unless a load (torque) with a predetermined magnitude or more is applied to the output shaft 21, the impact mechanism 17 causes the output shaft 21 to turn continuously with the rotational power of the motor 15. That is to say, in that case, the drive shaft 22 and the hammer 19 that are coupled to each other via the cam mechanism rotate integrally with each other and the hammer 19 and the anvil 20 also rotate integrally with each other. Thus, the output shaft 21 formed integrally with the anvil 20 rotates.

On the other hand, upon the application of a load with a predetermined magnitude or more to the output shaft 21, the impact mechanism 17 performs an impact operation. In performing the impact operation, the impact mechanism 17 generates impacting force by transforming the rotational power of the motor 15 into pulses of torque. That is to say, while the impact operation is being performed, the hammer 19 retreats by overcoming the biasing force applied by the spring 24 (i.e., goes away from the anvil 20) while being regulated by the cam mechanism between the drive shaft 22 and the hammer 19 itself. At a point in time when the hammer 19 retreats to be decoupled from the anvil 20, the hammer 19 starts advancing (i.e., moving toward the output shaft 21) while rotating, thereby applying impacting force to the anvil 20 in the rotational direction and causing the output shaft 21 to rotate. That is to say, the impact mechanism 17 applies rotational impact around the axis (of the output shaft 21) to the output shaft 21 via the anvil 20. While the impact mechanism 17 is performing the impact operation, the hammer 19 repeatedly performs the operation of applying impacting force to the anvil 20 in the rotational direction. Every time the hammer 19 advances and retreats, the impacting force is generated.

The trigger volume 29 is an operating member for accepting the operation of controlling the rotation of the motor 15. The motor 15 may be selectively activated (turned ON or OFF) by the operation of pulling the trigger volume 29. In addition, the rotational velocity of the output shaft 21 (i.e., the rotational velocity of the motor 15) is adjustable depending on the manipulative variable of the operation of pulling the trigger volume 29 (i.e., depending on how deep the trigger volume 29 is pulled). The greater the manipulative variable is, the higher the rotational velocity of the motor 15 becomes. The control unit 44 either starts or stops rotating the motor 15, and controls the rotational velocity of the motor 15, according to the manipulative variable of the operation of pulling the trigger volume 29. In this electric tool 1, the tip tool 28 is attached to the socket 23. In addition, the rotational velocity of the motor 15 is controlled in response to the operation performed on the trigger volume 29, thereby controlling the rotational velocity of the tip tool 28.

The torque measuring unit 41 measures the torque applied to the output shaft 21. The torque measuring unit 41 may be, for example, a magnetostrictive strain sensor which may detect torsional strain. The magnetostrictive strain sensor makes a coil, installed in a non-rotating portion near the output shaft 21, detect a variation in permeability due to a strain caused by the application of torque to the output shaft 21 and outputs a voltage signal proportional to the strain thus detected.

The acceleration sensor 42 is attached to the output shaft 21. The acceleration sensor 42 measures the acceleration of the output shaft 21 in the circumferential direction and outputs a voltage signal proportional to the acceleration thus measured. Alternatively, the acceleration sensor 42 may also be configured to measure an angular acceleration of the output shaft 21.

The case 45 houses the fastening torque calculating unit 43 and the control unit 44.

The fastening torque calculating unit 43 and the control unit 44 may be implemented as, for example, a microcontroller. That is to say, the fastening torque calculating unit 43 and the control unit 44 include a computer system including one or more processors and a memory. In this case, a single microcontroller may perform the functions of both the fastening torque calculating unit 43 and the control unit 44. Alternatively, a microcontroller performing the function of the fastening torque calculating unit 43 and a microcontroller performing the function of the control unit 44 may be provided separately from each other.

The fastening torque calculating unit 43 calculates, based on the torque (measured torque) measured by the torque measuring unit 41, the torque (fastening torque) to be applied to the fastening member 30. The fastening torque calculating unit 43 calculates the fastening torque at least while the impact mechanism 17 is applying rotational impact to the output shaft 21. The fastening torque is calculated in every predetermined time (e.g., every millisecond). The fastening torque calculating unit 43 calculates the fastening torque by, for example, the following Equation (1):

T1=T2×C1−I1×a1×C2+C3 (1)

where T1 is the fastening torque, T2 is the measured torque, C1-C3 are correction coefficients, I1 is the moment of inertia of the tip portion of the output shaft 21, the socket 23, and the tip tool 28 combined, and a1 is the angular velocity of the output shaft 21. More specifically, the tip portion of the output shaft 21 herein refers to a part, located closer to the tip than the torque measuring unit 41, of the output shaft 21. The angular velocity a1 of the output shaft 21 is calculated, based on the measured value of the acceleration sensor 42, by the fastening torque calculating unit 43.

(3) Operation

The control unit 44 controls the operation of the motor 15. More specifically, the control unit 44 controls the number of revolutions of the motor 15 by controlling the current supplied from the power supply 32 to the motor 15. The control unit 44 may perform, for example, feedback control on the number of revolutions of the motor 15 as described above.

The control unit 44 has the following speed reducing function. Specifically, the control unit 44 performs the speed reducing function by changing, according to the fastening torque calculated by the fastening torque calculating unit 43, the number of revolutions of the motor 15 from a first number of revolutions into a second number of revolutions. The second number of revolutions is smaller than the first number of revolutions.

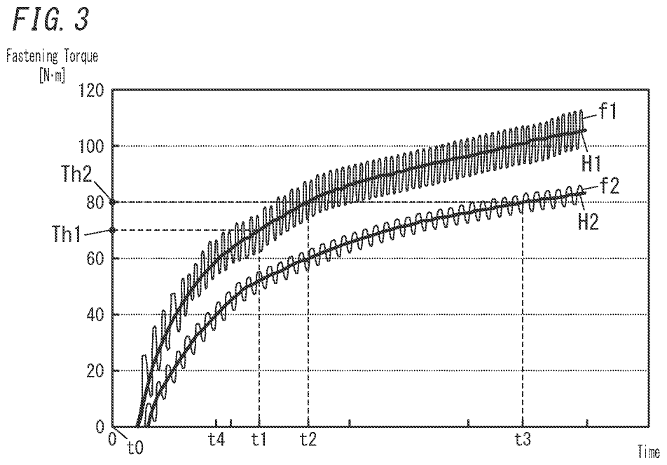

More specifically, the control unit 44 performs the speed reducing function by changing, when finding the fastening torque calculated by the fastening torque calculating unit 43 greater than a torque threshold value Th1 (refer to FIG. 3), the number of revolutions of the motor 15 from the first number of revolutions into the second number of revolutions. In addition, the control unit 44 performs the speed reducing function by stopping the motor 15 on detecting that the fastening torque calculated by the fastening torque calculating unit 43 has reached a target torque Th2 (refer to FIG. 3). The target torque Th2 is greater than the torque threshold value Th1. The torque threshold value Th1 and the target torque Th2 are stored in advance in the memory of a computer system that performs the functions of the fastening torque calculating unit 43 and the control unit 44.

Also, the control unit 44 has a first mode and a second mode. In the first mode, the control unit 44 performs the speed reducing function. In the second mode, the control unit 44 does not perform the speed reducing function. In the second mode, the control unit 44 maintains the number of revolutions of the motor 15 at the first number of revolutions, irrespective of the fastening torque calculated by the fastening torque calculating unit 43.

The electric tool 1 may include, for example a user interface that accepts an operation of switching the operation mode from the first mode to the second mode, and vice versa. Examples of the user interface include a button, a slide switch, and a touchscreen panel. The control unit 44 switches the operation mode between the first mode and the second mode in accordance with the user's operating command entered through the user interface.

Alternatively, the electric tool 1 may include, for example, a receiver for accepting input of a signal to switch the operation mode from the first mode to the second mode, or vice versa. The receiver receives the signal from an external device outside of the electric tool 1. In response to the signal received, the control unit 44 switches the operation mode between the first mode and the second mode. The communication between the external device and the receiver may be either wireless communication or wired communication, whichever is appropriate.

The functions of the electric tool 1 may also be implemented as, for example, a method for controlling the electric tool 1, a (computer) program, or a non-transitory storage medium that stores the program thereon. A program according to an aspect is designed to cause one or more processors to perform the method for controlling the electric tool 1. In the following description, an exemplary method for controlling the electric tool 1 will be described as an exemplary operation of the electric tool 1. First, an exemplary operation of the electric tool 1 in a situation where the operation mode of the control unit 44 is the first mode will be described.

A method for controlling the electric tool 1 according to an aspect is designed to control an electric tool 1 including a motor 15, an impact mechanism 17, an output shaft 21, and a torque measuring unit 41. The impact mechanism 17 receives motive power from the motor 15 to generate impacting force. The output shaft 21 holds a tip tool 28 thereon. The tip tool 28 applies either tightening force or loosening force to a fastening member 30. The output shaft 21 receives, from the impact mechanism 17, rotational impact around an axis. The torque measuring unit 41 measures, as measured torque, torque applied to the output shaft 21.

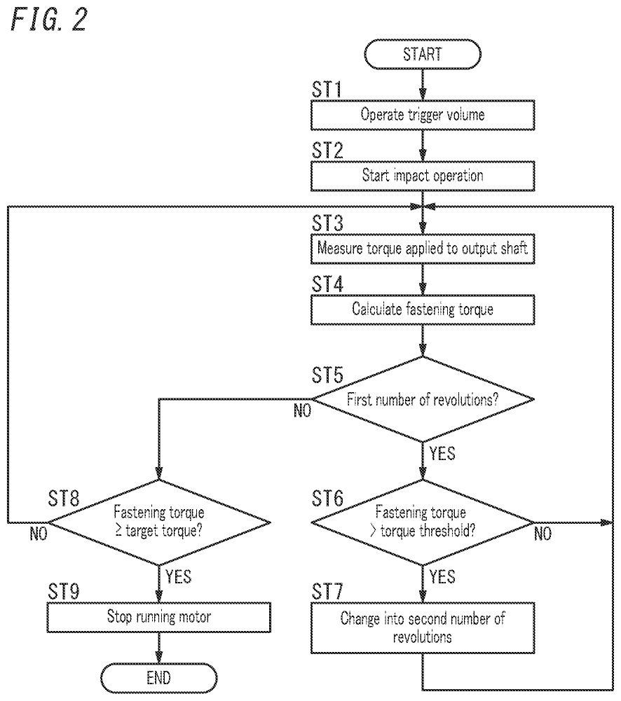

FIG. 2 is a flowchart showing an exemplary method for controlling the electric tool 1. The method for controlling the electric tool 1 includes a calculating step ST4 and a speed reducing step (including Steps ST6, ST7). The calculating step ST4 includes calculating, based on the measured torque measured by the torque measuring unit 41, fastening torque to be applied to the fastening member 30. The speed reducing step (including Steps ST6, ST7) includes changing, according to the fastening torque calculated in the calculating step ST4, the number of revolutions of the motor 15 from a first number of revolutions into a second number of revolutions. The second number of revolutions is smaller than the first number of revolutions.

An exemplary method for controlling the electric tool 1 will be described in further detail. First, the worker performs the operation of pulling the trigger volume 29 (in Step ST1), thus causing the motor 15 to start running. If the worker has pulled the trigger volume 29 to a maximum depth, then the number of revolutions of the motor 15 will be the first number of revolutions. When a load, of which the magnitude is equal to or greater than a predetermined magnitude, is applied to the output shaft 21, the impact mechanism 17 starts performing the impact operation (in Step ST2). The torque measuring unit 41 measures, as the measured torque, the torque applied to the output shaft 21 (in Step ST3). The fastening torque calculating unit 43 performs the calculating step ST4 to calculate the fastening torque. If the number of revolutions of the motor 15 is the first number of revolutions (if the answer is YES in Step ST5), the control unit 44 performs the speed reducing step (including Steps ST6, ST7). First, in Step ST6, the control unit 44 compares the fastening torque with the torque threshold value Th1. If the fastening torque is equal to or less than the torque threshold value Th1 (if the answer is NO in Step ST6), the process goes back to Step ST3. On the other hand, if the fastening torque is greater than the torque threshold value Th1 (if the answer is YES in Step ST6), the control unit 44 changes the number of revolutions of the motor 15 from the first number of revolutions into the second number of revolutions (in Step ST7). Meanwhile, if the number of revolutions of the motor 15 turns out, in Step ST5, to be the second number of revolutions, not the first number of revolutions (if the answer is NO in Step ST5), the control unit 44 compares the fastening torque with the target torque Th2. If the fastening torque is less than the target torque Th2 (if the answer is NO in Step ST8), the process goes back to Step ST3. When the fastening torque reaches the target torque Th2 (if the answer is YES in Step ST8), the control unit 44 makes the motor 15 stop running (in Step ST9).

FIG. 3 shows how the fastening torque calculated by the fastening torque calculating unit 43 changes with time while the impact mechanism 17 is applying rotational impact to the output shaft 21. In FIG. 3, the fastening torque is normalized. Specifically, in FIG. 3, the fastening torque when the motor 15 is turning at a constant velocity is represented as zero. That is to say, an increment with respect to the fastening torque when the motor 15 is turning at a constant velocity is shown in FIG. 3.

In FIG. 3, f1 represents an instantaneous value of the fastening torque when the number of revolutions of the motor 15 is the first number of revolutions. H1 is an approximation function of the instantaneous value f1 where time is an independent variable. More specifically, the approximation function H1 may be, for example, a function where the instantaneous value f1 is obtained by polynomial approximation.

In FIG. 3, f2 represents an instantaneous value of the fastening torque when the number of revolutions of the motor 15 is the second number of revolutions. H2 is an approximation function of the instantaneous value f2 where time is an independent variable. More specifically, the approximation function H2 may be, for example, a function where the instantaneous value f2 is obtained by polynomial approximation.

The control unit 44 controls the number of revolutions of the motor 15 in accordance with at least one of the instantaneous value of the fastening torque or the value of the approximation function. Specifically, if the number of revolutions of the motor 15 is the first number of revolutions, the control unit 44 controls the number of revolutions of the motor 15 in accordance with at least one of the instantaneous value f1 or the value of the approximation function H1. On the other hand, if the number of revolutions of the motor 15 is the second number of revolutions, the control unit 44 controls the number of revolutions of the motor 15 in accordance with at least one of the instantaneous value f2 or the value of the approximation function H2. In the following description, a situation where the control unit 44 obtains either the approximation function H1 of the fastening torque or the approximation function H2 of the fastening torque and controls the number of revolutions of the motor 15 in accordance with either the value of the approximation function H1 or the value of the approximation function H2 will be described as an example. That is to say, the control unit 44 performs the speed reducing function by obtaining, based on the fastening torque, the approximation function H1, H2 representing the relation between the fastening torque and time. The control unit 44 changes the number of revolutions of the motor 15 from the first number of revolutions into the second number of revolutions according to the value of the approximation function H1, H2.

In FIG. 3, the first number of revolutions may be, for example, 15500 rpm and the second number of revolutions may be, for example, 10500 rpm. The torque threshold value Th1 may be, for example, 70 N·m and the target torque Th2 may be, for example, 80 N·m.

If the worker has pulled the trigger volume 29 of the electric tool 1 to the maximum depth while the impact mechanism 17 is applying rotational impact to the output shaft 21 (hereinafter referred to as “at the time of impact operation”), then the number of revolutions of the motor 15 will be the first number of revolutions. As time passes since the start of the impact operation (at a time t0), the value of the approximation function H1 increases.

At a time t1, the value of the approximation function H1 exceeds the torque threshold value Th1. In response, the control unit 44 changes the number of revolutions of the motor 15 from the first number of revolutions into the second number of revolutions. That is to say, the control unit 44 reduces the speed (rotational velocity) of the motor 15. As a result, from the time t1 on, the approximation function corresponding to the fastening torque changes from H1 into H2. That is to say, the instantaneous value of the fastening torque and the value of the approximation function both decrease.

While the number of revolutions of the motor 15 is the second number of revolutions, the control unit 44 does not decrease the number of revolutions of the motor 15 even if the approximation function H2 of the fastening torque exceeds the torque threshold value Th1. In the state where the number of revolutions of the motor 15 is the second number of revolutions, the value of the approximation function H2 reaches the target torque Th2 at a time t3. In response, the control unit 44 stops running the motor 15.

In the foregoing description, it has been described how the control unit 44 operates when its operation mode is the first mode. On the other hand, when the operation mode of the control unit 44 is the second mode, the control unit 44 maintains the number of revolutions of the motor 15 at the first number of revolutions. In that case, the value of the approximation function H1 of the fastening torque reaches the target torque Th2 at a time t2 between the time t1 and the time t3.

In this case, the smaller the number of revolutions of the motor 15 is, the smaller the increase in the value of the approximation function per unit time becomes. Referring to FIG. 3, it can be seen that the gradient of the approximation function H2 in the vicinity of the target torque Th2 when the number of revolutions of the motor 15 is the second number of revolutions is less steep than the gradient of the approximation function H1 in the vicinity of the target torque Th2 when the number of revolutions of the motor 15 is the first number of revolutions. That is to say, when the number of revolutions of the motor 15 is the second number of revolutions, the value of the approximation function H2 of the fastening torque increases in the vicinity of the target torque Th2 more gently than when the number of revolutions of the motor 15 is the first number of revolutions. This allows the motor 15 to stop running while the increase in the value of the approximation function H2 is relatively small after the value of the approximation function H2 of the fastening torque has reached the target torque Th2. That is to say, changing the number of revolutions of the motor 15 from the first number of revolutions into the second number of revolutions may reduce the chances of the value of the approximation function H2 significantly surpassing the target torque Th2. In other words, this reduces the chances of fastening torque much greater than the target torque Th2 being applied to the fastening member 30.

In addition, the smaller the number of revolutions of the motor 15 is, the smaller the dispersion in the instantaneous value of the fastening torque becomes. That is why the instantaneous value f2 has a smaller degree of dispersion than the instantaneous value f1. That is to say, in FIG. 3, although each of the instantaneous values f1, f2 has a pattern consisting of repetitive pulses, the pulses that form the instantaneous value f2 have smaller amplitude than pulses that form the instantaneous value f1. As can be seen, changing the number of revolutions of the motor 15 from the first number of revolutions into the second number of revolutions (i.e., reducing the speed of the motor 15) may reduce the dispersion in the instantaneous value of the fastening torque, thus improving the accuracy of control of the fastening torque.

Furthermore, reducing the dispersion in the instantaneous value of the fastening torque may also reduce the chances of the instantaneous value f2 of the fastening torque significantly surpassing the target torque Th2.

Besides, this also makes the fastening torque at an initial stage of the impact operation (i.e., from the time t0 through the time t1) greater than in a situation where the number of revolutions of the motor 15 is set at the second number of revolutions from the beginning. This shortens the time it takes to fasten the fastening member 30.

(First Variation)

Next, an electric tool 1 according to a first variation will be described with reference to FIG. 3. In the following description, any constituent element of this first variation, having the same function as a counterpart of the exemplary embodiment described above, will be designated by the same reference numeral as that counterpart's, and description thereof will be omitted herein.

The control unit 44 according to the first variation performs the speed reducing function by changing, according to the fastening torque and the number of times the impact mechanism 17 has performed the impact operation (hereinafter simply referred to as “the number of times of impact operations performed”), the number of revolutions of the motor 15 from the first number of revolutions into the second number of revolutions. As used herein, the “number of times of impact operations performed” refers to the number of times the hammer 19 has struck the anvil 20 from a reference point in time (e.g., the time t0 when the impact operation starts to be performed, in this example).

When a predetermined period of time has passed since the reference point in time (e.g., at a time t4 between the time t0 and the time t1 in this example), the control unit 44 performs the following processing. Specifically, the control unit 44 obtains the approximation function H1 based on the instantaneous value f1 from the time t0 through the time t4. This allows an approximation function H1 representing at least the fastening torque up to a time t2 when the value of the approximation function H1 reaches the target torque Th2 to be obtained (i.e., estimated).

The control unit 44 associates the approximation function H1 with the number of times that the impact mechanism 17 has performed the impact operations. That is to say, the control unit 44 determines, based on the cycle in which the impact operation is performed by the impact mechanism 17, the relation between the value of the approximation function H1 and the number of times of impact operations performed. Then the control unit 44 calculates (estimates), based on the approximation function H1, the number of times of impact operations performed when the value of the approximation function H1 reaches the target torque Th2 (hereinafter referred to as a “final number of times of impact operations performed”). The control unit 44 defines the torque threshold value Th1 to be the fastening torque corresponding, in the approximation function H1, to the number of times of impact operations performed calculated by subtracting a predetermined value from the final number of times of impact operations performed (hereinafter referred to as a “differential number of times of impact operations performed”). For example, if the final number of times of impact operations performed is 50 times and the predetermined value is 10 times, then the control unit 44 defines the torque threshold value Th1 to be fastening torque when the number of times of impact operations performed is 40 times according to the approximation function H1.

Alternatively, the control unit 44 may obtain the approximation function H1 as a function with respect to the number of times the impact mechanism 17 has performed impact operations, not as a function with respect to time.

Optionally, the control unit 44 may perform a predetermined type of control if the value of the approximation function H1 has never reached the torque threshold value Th1 in a situation where the number of times of impact operations performed has either reached the differential number of times of impact operations performed or exceeded the differential number of times of impact operations performed by a predetermined number of times. Examples of the predetermined types of control include stopping running the motor 15 and making notification about the abnormality of the electric tool 1.

(Second Variation)

Next, an electric tool 1 according to a second variation will be described. In the following description, any constituent element of this second variation, having the same function as a counterpart of the exemplary embodiment described above, will be designated by the same reference numeral as that counterpart's, and description thereof will be omitted herein.

The control unit 44 according to this second variation has the function of changing the ratio of the first number of revolutions to the second number of revolutions. The control unit 44 changes the ratio of the first number of revolutions to the second number of revolutions by changing at least one of the first number of revolutions or the second number of revolutions.

The electric tool 1 may include, for example, a user interface that accepts the operation of changing the ratio of the first number of revolutions to the second number of revolutions. Examples of the user interface include a button, a slide switch, and a touchscreen panel. The control unit 44 changes the ratio of the first number of revolutions to the second number of revolutions in accordance with the user's operating command entered through the user interface.

Alternatively, the electric tool 1 may include, for example, a receiver for accepting input of a signal to change the ratio of the first number of revolutions to the second number of revolutions. The receiver receives the signal from an external device outside of the electric tool 1. In response to the signal received, the control unit 44 changes the ratio of the first number of revolutions to the second number of revolutions. The communication between the external device and the receiver may be either wireless communication or wired communication, whichever is appropriate.

The ratio of the first number of revolutions to the second number of revolutions may be either selected from a plurality of values or changed continuously, whichever is appropriate.

According to the second variation, the ratio of the first number of revolutions to the second number of revolutions may be changed as needed. The ratio of the first number of revolutions to the second number of revolutions may be changed according to, for example, the degree of accuracy required in controlling the fastening torque. That is to say, if a relatively high degree of accuracy is required, the ratio of the first number of revolutions to the second number of revolutions may be increased. On the other hand, if the degree of accuracy may be relatively low, the ratio of the first number of revolutions to the second number of revolutions may be decreased.

### Other Variations of Embodiment

Next, other variations of the exemplary embodiment will be enumerated one after another. The variations to be described below may be adopted in combination as appropriate. Alternatively, the variations to be described below may also be adopted as appropriate in combination with any of the variations described above.

The electric tool 1 according to the present disclosure includes a computer system as a constituent element of at least the fastening torque calculating unit 43 and the control unit 44. The computer system includes a processor and a memory as principal hardware components thereof. The functions of the fastening torque calculating unit 43 and the control unit 44 according to the present disclosure are performed by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits include a system LSI, a very-large-scale integrated circuit (VLSI), and an ultra-large-scale integrated circuit (VLSI). Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

Also, in the embodiment described above, the plurality of functions of each of the fastening torque calculating unit 43 and the control unit 44 are integrated together in a single housing. However, this is not an essential configuration for the fastening torque calculating unit 43 and the control unit 44. Alternatively, those constituent elements of each of the fastening torque calculating unit 43 and the control unit 44 may be distributed in multiple different housings. Still alternatively, the fastening torque calculating unit 43 and the control unit 44 may also be distributed in multiple different housings. Yet alternatively, at least some functions of the fastening torque calculating unit 43 and the control unit 44 (e.g., at least some functions of the fastening torque calculating unit 43) may be implemented as a cloud computing system as well.

Furthermore, in the foregoing description, if one of two values being compared with each other is “equal to or greater than” the other, this phrase may herein cover both a situation where these two values are equal to each other and a situation where one of the two values is greater than the other. However, this should not be construed as limiting. Alternatively, the phrase “equal to or greater than” may also be a synonym of the phrase “greater than” that covers only a situation where one of the two values is over the other. That is to say, it is arbitrarily changeable, depending on selection of a reference value or any preset value, whether or not the phrase “equal to or greater than” covers the situation where the two values are equal to each other. Therefore, from a technical point of view, there is no difference between the phrase “equal to or greater than” and the phrase “greater than.” Similarly, the phrase “equal to or less than” may be a synonym of the phrase “less than” as well. In other words, from a technical point of view, there is no difference between the phrase “equal to or less than” and the phrase “less than.”

The motor 15 does not have to be a brushless motor but may also be a brush motor.

The motor 15 does not have to be an AC motor but may also be a DC motor.

The control unit 44 may change the number of revolutions of the motor 15 in three or more steps. Alternatively, the control unit 44 may change the number of revolutions of the motor 15 continuously (i.e., with no steps defined).

The control unit 44 may decrease, when changing the number of revolutions of the motor 15 from the first number of revolutions into the second number of revolutions, the number of revolutions of the motor 15 with the passage of time.

Optionally, the control unit 44 may not only change the number of revolutions of the motor 15 from the first number of revolutions into the second number of revolutions but also perform control in the following manner, for example. Specifically, if the number of revolutions of the motor 15 is equal to or greater than a third number of revolutions, the control unit 44 may change the number of revolutions of the motor 15 from a current number of revolutions into a smaller number of revolutions depending on a condition. The third number of revolutions has a value greater than the second number of revolutions and equal to or less than the first number of revolutions. The condition may be, for example, the same as the condition on which the control unit 44 changes the number of revolutions of the motor 15 from the first number of revolutions into the second number of revolutions in the exemplary embodiment described above. The number of revolutions of the motor 15 may be either changed into a different number of revolutions according to the number of revolutions of the motor 15 at a point in time just before the change of the number of revolutions or always changed into the second number of revolutions, whichever is appropriate.

In one variation, in a state where the number of revolutions of the motor 15 is equal to or greater than the third number of revolutions, the control unit 44 decreases the number of revolutions of the motor 15 once the fastening torque exceeds the torque threshold value Th1. As long as the number of revolutions of the motor 15 is less than the third number of revolutions, the control unit 44 does not decrease the number of revolutions of the motor 15 even if the fastening torque exceeds the torque threshold value Th1.

In the exemplary embodiment described above, if the fastening torque is equal to or less than the torque threshold value Th1, the first number of revolutions is the number of revolutions of the motor 15 when the trigger volume 29 has been pulled to the maximum depth. However, this is only an example and should not be construed as limiting. Alternatively, the first number of revolutions may also be the number of revolutions of the motor 15 when the trigger volume 29 has been pulled to a predetermined depth smaller than the maximum depth.

The control unit 44 may calculate (estimate), based on the approximation function H1, a point in time when the value of the approximation function H1 reaches the target torque Th2 and may define, based on the approximation function H1, the torque threshold value Th1 to be fastening torque at a point in time determined by subtracting a predetermined time from the point in time.

The value of the approximation function H1, H2 does not have to be obtained by subjecting the instantaneous value f1, f2 to polynomial approximation. Alternatively, linear approximation, log approximation, or power approximation, for example, may be adopted instead of the polynomial approximation. Still alternatively, a value obtained by calculating a time average of the instantaneous value f1 may be adopted as the value of the approximation function H1. Likewise, a value obtained by calculating a time average of the instantaneous value f2 may also be adopted as the value of the approximation function H2. The approximation function H1, H2 may be a curved function or a linear function, whichever is appropriate.

The control unit 44 does not have to compare the value of the approximation function H1, H2 of the fastening torque with the torque threshold value Th1 and the target torque Th2. Alternatively, the control unit 44 may compare the instantaneous value f1, f2 of the fastening torque with at least one of the torque threshold value Th1 or the target torque Th2. Then, the control unit 44 may control the operation of the motor 15 based on the result of comparison.

The control unit 44 may control the number of revolutions of the motor 15 without depending on the depth to which the trigger volume 29 has been pulled. That is to say, in the electric tool 1 according to the present disclosure, the control unit 44 controls the number of revolutions of the motor 15 automatically to prevent the fastening torque from surpassing the target torque Th2 significantly. Thus, the number of revolutions of the motor 15 does not have to be adjusted in accordance with the worker's operating command entered through the trigger volume 29.

The torque measuring unit 41 does not have to be a magnetostrictive strain sensor. Alternatively, the torque measuring unit 41 may also be, for example, a resistive strain sensor. The resistive strain sensor is affixed to the surface of the output shaft 21. The resistive strain sensor measures the strain of the output shaft 21. That is to say, the resistive strain sensor transforms an electrical resistance value, corresponding to the strain generated upon the application of torque to the output shaft 21, into a voltage signal and outputs the voltage signal as a result of measurement.

The tip tool 28 does not have to be one of the constituent elements of the electric tool 1.

(Recapitulation)

The exemplary embodiment and its variations described above are specific implementations of the following aspects of the present disclosure.

An electric tool (1) according to a first aspect includes a motor (15), an impact mechanism (17), an output shaft (21), a torque measuring unit (41), a fastening torque calculating unit (43), and a control unit (44). The impact mechanism (17) receives motive power from the motor (15) to generate impacting force. The output shaft (21) holds a tip tool (28) thereon. The tip tool (28) applies either tightening force or loosening force to a fastening member (30). The output shaft (21) receives, from the impact mechanism (17), rotational impact around an axis. The torque measuring unit (41) measures, as measured torque, torque applied to the output shaft (21). The fastening torque calculating unit (43) calculates, based on the measured torque measured by the torque measuring unit (41), fastening torque to be applied to the fastening member (30). The control unit (44) controls operation of the motor (15). The control unit (44) has a speed reducing function. The control unit (44) performs the speed reducing function by changing, according to the fastening torque calculated by the fastening torque calculating unit (43), the number of revolutions of the motor (15) from a first number of revolutions into a second number of revolutions. The second number of revolutions is smaller than the first number of revolutions.

According to this configuration, the speed reducing function performed by the control unit (44) reduces the speed of the motor (15) such that the number of revolutions of the motor (15) changes from the first number of revolutions into the second number of revolutions, thus reducing a variation in fastening torque with time. This improves, when the fastening torque needs to be controlled highly accurately, the accuracy of control of the fastening torque by making the control unit (44) perform the speed reducing function to reduce the speed of the motor (15).

In an electric tool (1) according to a second aspect, which may be implemented in conjunction with the first aspect, the control unit (44) performs the speed reducing function by changing, when finding the fastening torque calculated by the fastening torque calculating unit (43) greater than a torque threshold value (Th1), the number of revolutions of the motor (15) from the first number of revolutions into the second number of revolutions.

According to this configuration, when the fastening torque becomes greater than the torque threshold value (Th1), the motor (15) slows down, thus reducing a variation in fastening torque with time. This reduces the chances of excessive fastening torque being applied due to the dispersion in fastening torque.

In an electric tool (1) according to a third aspect, which may be implemented in conjunction with the second aspect, the control unit (44) performs the speed reducing function by stopping the motor (15) on detecting that the fastening torque calculated by the fastening torque calculating unit (43) has reached a target torque (Th2). The target torque (Th2) is greater than the torque threshold value (Th1).

According to this configuration, when the fastening torque reaches the target torque (Th2), the motor (15) stops running, thus reducing the chances of excessive fastening torque being applied.

In an electric tool (1) according to a fourth aspect, which may be implemented in conjunction with any one of the first to third aspects, the control unit (44) performs the speed reducing function by obtaining, based on the fastening torque, an approximation function (H1, H2) representing a relation between the fastening torque and time and changing, according to a value of the approximation function (H1, H2), the number of revolutions of the motor (15) from the first number of revolutions into the second number of revolutions.

This configuration may reduce the negative impact of a pulsed variation in the instantaneous value (f1, f2) of the fastening torque.

In an electric tool (1) according to a fifth aspect, which may be implemented in conjunction with any one of the first to fourth aspects, the control unit (44) has the function of changing a ratio of the first number of revolutions to the second number of revolutions.

This configuration allows the ratio of the first number of revolutions to the second number of revolutions to be changed as needed.

In an electric tool (1) according to a sixth aspect, which may be implemented in conjunction with any one of the first to fifth aspects, the control unit (44) performs the speed reducing function by changing, according to the fastening torque and a number of times the impact mechanism (17) has performed an impact operation, the number of revolutions of the motor (15) from the first number of revolutions into the second number of revolutions.

This configuration allows the control unit (44) to make a more precise decision than in a situation where the control unit (44) determines, based on only the fastening torque, whether the speed of the motor (15) should be reduced or not.

In an electric tool (1) according to a seventh aspect, which may be implemented in conjunction with any one of the first to sixth aspects, the control unit (44) has: a first mode in which the control unit (44) performs the speed reducing function; and a second mode in which the control unit (44) maintains the number of revolutions of the motor (15) at the first number of revolutions.

This configuration allows the control unit (44) to selectively perform the speed reducing function depending on the necessity.

Note that the constituent elements according to the second to seventh aspects are not essential constituent elements for the electric tool (1) but may be omitted as appropriate.

A method for controlling an electric tool (1) according to an eighth aspect is designed to control an electric tool (1) including a motor (15), an impact mechanism (17), an output shaft (21), and a torque measuring unit (41). The impact mechanism (17) receives motive power from the motor (15) to generate impacting force. The output shaft (21) holds a tip tool (28) thereon. The tip tool (28) applies either tightening force or loosening force to a fastening member (30). The output shaft (21) receives, from the impact mechanism (17), rotational impact around an axis. The torque measuring unit (41) measures, as measured torque, torque applied to the output shaft (21). The method for controlling the electric tool (1) includes a calculating step (ST4) and a speed reducing step (Steps (ST5, ST6)). The calculating step (ST4) includes calculating, based on the measured torque measured by the torque measuring unit (41), fastening torque to be applied to the fastening member (30). The speed reducing step includes changing, according to the fastening torque calculated in the calculating step (ST4), a number of revolutions of the motor (15) from a first number of revolutions into a second number of revolutions. The second number of revolutions is smaller than the first number of revolutions.

This method improves, when the fastening torque needs to be controlled highly accurately, the accuracy of control of the fastening torque by making the control unit (44) perform the speed reducing function to reduce the speed of the motor (15).

A program according to a ninth aspect is designed to cause one or more processors to perform the method for controlling the electric tool (1) according to the eighth aspect.

This improves, when the fastening torque needs to be controlled highly accurately, the accuracy of control of the fastening torque by making the control unit (44) perform the speed reducing function to reduce the speed of the motor (15).

Note that these are not the only aspects of the present disclosure but various configurations (including variations) of the electric tool (1) according to the exemplary embodiment described above may also be implemented as, for example, a method for controlling the electric tool (1) and a program.

### REFERENCE SIGNS LIST

1 Electric Tool
15 Motor
17 Impact Mechanism
21 Output Shaft
28 Tip Tool
30 Fastening Member
41 Torque Measuring Unit
43 Fastening Torque Calculating Unit
44 Control Unit
H1, H2 Approximation Function
Th1 Torque Threshold Value
Th2 Target Torque

1. An electric tool comprising:
a motor;
an impact mechanism configured to receive motive power from the motor to generate impacting force;
an output shaft configured to hold a tip tool for use to apply either tightening force or loosening force to a fastening member, the output shaft being configured to receive, from the impact mechanism, rotational impact around an axis;
a torque measuring unit configured to measure, as measured torque, torque applied to the output shaft;
a fastening torque calculating unit configured to calculate, based on the measured torque measured by the torque measuring unit, fastening torque to be applied to the fastening member; and
a control unit configured to control operation of the motor,
the control unit having a speed reducing function of changing, according to the fastening torque calculated by the fastening torque calculating unit, a number of revolutions of the motor from a first number of revolutions into a second number of revolutions, the second number of revolutions being smaller than the first number of revolutions.

2. The electric tool of claim 1, wherein
the control unit is configured to perform the speed reducing function by changing, when finding the fastening torque calculated by the fastening torque calculating unit greater than a torque threshold value, the number of revolutions of the motor from the first number of revolutions into the second number of revolutions.

3. The electric tool of claim 2, wherein
the control unit is configured to perform the speed reducing function by stopping the motor on detecting that the fastening torque calculated by the fastening torque calculating unit has reached a target torque, the target torque being greater than the torque threshold value.

4. The electric tool of claim 1, wherein
the control unit is configured to perform the speed reducing function by obtaining, based on the fastening torque, an approximation function representing a relation between the fastening torque and time and changing, according to a value of the approximation function, the number of revolutions of the motor from the first number of revolutions into the second number of revolutions.

5. The electric tool of claim 1, wherein
the control unit has a function of changing a ratio of the first number of revolutions to the second number of revolutions.

6. The electric tool of claim 1, wherein
the control unit is configured to perform the speed reducing function by changing, according to the fastening torque and a number of times the impact mechanism has performed an impact operation, the number of revolutions of the motor from the first number of revolutions into the second number of revolutions.

7. The electric tool of claim 1, wherein
the control unit has: a first mode in which the control unit performs the speed reducing function; and a second mode in which the control unit maintains the number of revolutions of the motor at the first number of revolutions.

8. A method for controlling an electric tool, the electric tool including:
a motor;
an impact mechanism configured to receive motive power from the motor to generate impacting force;
an output shaft configured to hold a tip tool for use to apply either tightening force or loosening force to a fastening member, the output shaft being configured to receive, from the impact mechanism, rotational impact around an axis; and
a torque measuring unit configured to measure, as measured torque, torque applied to the output shaft,
the method comprising:
a calculating step including calculating, based on the measured torque measured by the torque measuring unit, fastening torque to be applied to the fastening member; and
a speed reducing step including changing, according to the fastening torque calculated in the calculating step, a number of revolutions of the motor from a first number of revolutions into a second number of revolutions, the second number of revolutions being smaller than the first number of revolutions.

9. A non-transitory computer-readable storage medium having stored thereon a computer program designed to cause one or more processors of the computer to perform the method for controlling the electric tool according to claim 8.
